(19) United States
(12) Patent Application Publication
(10) Pub. No.: US 2011/0023225 A1
(43) Pub. Date: Feb. 3, 2011

(54) Portable spa with variable speed throttling water massage system

(76) Inventors: Victor Kaykov, Lakeland, FL (US); Bradford Thomas Tatum, Clearwater, FL (US)

Correspondence Address: SMITH HOPEN, PA, 180 PINE AVENUE NORTH, OLDSMAR, FL, 34677, US

(21) Appl. No.: 12/315,175

(22) Filed: Nov. 28, 2008

Related U.S. Application Data
(60) Provisional application No. 61/004,492, filed on Nov. 27, 2007.

(51) Int. Cl. A61H 33/00

(52) U.S. Cl. 4/541.1

(57) ABSTRACT

The present invention is directed to a portable spa with a throttling system having a throttling parameter, a sequencing parameter, and a time parameter, wherein water is discharged at varying rates and pressures through different sequences of jet groups for an interval of time. The throttling system includes a variable speed pump that supplies water to a manifold associated with a grouping of water discharge jets. The throttling system also includes a throttling module having a plurality of programmed operating modes that control the operation of the variable speed pump for throttle controlled distribution of water consistent with the throttling, sequencing and time parameters. During operation of the throttling system, the variable speed pump, the manifold, and the throttling module collectively interact to supply water to the plurality of jets, whereby the plurality of jets, discharge the water into the shell according to the operating mode and parameters.

### CROSS-REFERENCE TO RELATED APPLICATIONS

The present invention claims priority to U.S. Provisional Patent Application No. 61/004,492, filed Nov. 27, 2007.

### FEDERALLY SPONSORED RESEARCH OR DEVELOPMENT

N/A

### TECHNICAL FIELD

The invention relates to a portable spa featuring a programmable variable speed throttling system for delivering water into the spa. More specifically, the invention provides a portable spa or hot tub with a programmable variable speed throttling system whereby water is supplied to and discharged from the jet assemblies in a manner designed to provide, for each user, an individually customizable variable speed throttling massage system and increases the spa's therapeutic benefits.

### BACKGROUND OF THE INVENTION

Portable spas, or hot tubs as they are also referred to, are well-known and can be found in both residential and commercial settings. Most portable spas include an arrangement of seats, such as recline, captain's and waterfall seats, and an array of discharge jets, such as directional, deep tissue, bullet, pulsing, and oscillating jets, incorporated within each seat. Water is pumped by an electric motor to a manifold and through lines or conduits to the jets that then discharge the water into the shell. Depending upon the number of jets in each seat, a manifold may be utilized between the pump and the jets to facilitate delivery of the water. As an example, a conventional spa has four seats wherein each seat has ten jets that are supplied with water pumped through the manifold and lines by the motor. Depending upon the number of seats and jets, a second motor may be employed wherein each motor pumps water to multiple seats and jets therein.

While such conventional portable spas provide some benefits, they nevertheless have certain limitations. For example, when the conventional spa is operating, all of the jets continuously discharge water into the spa shell in a static or fixed discharge pattern dictated by the placement of the jets and at a fixed or static discharge rate. As a result, those people utilizing the spa cannot alter the water delivery provided by the jets or vary the intensity of the water applied to their body. The static discharge pattern and fixed discharge rate can become monotonous to the user and lessen the therapeutic benefits provided by the spa. Over time, this limitation may lead the spa owner to become disenchanted with the performance of the portable spa.

The present invention is provided to solve the limitations of conventional portable spas discussed above and other problems, and to provide advantages and aspects not provided by prior portable spas. A full discussion of the features and advantages of the present invention is deferred to the following detailed description, which follows with reference to the accompanying drawings.

### SUMMARY OF THE INVENTION

The present invention is directed to a portable spa featuring a variable speed throttling system wherein jets discharge the water into the spa shell in a manner designed to provide, for each user, an individually customizable variable speed throttling massage system and increases the spa's therapeutic benefits. The present invention further provides an efficient portable spa with respect to stand-by electrical consumption. The spa shell or tub includes a seating arrangement, wherein the throttling system is associated with an individual seat. The throttling system comprises a variable speed motor pump, a throttling module and a throttling module interface in electrical communication with each other and with a primary controller.

According to another aspect of the invention, the operation of the throttling system involves a sequencing parameter, a throttling parameter and a time parameter, which combine to define the sequencing and throttling of discharged water over set time intervals. Consequently, the person sitting in the seat experiences a massaging application of throttled water upon his/her body parts/regions as water is discharged from the various jets over different time intervals. Once the user selects the desired operating mode using the throttling module interface, the throttling module sends signals to the other components of the system to effectuate the operating mode. Unlike conventional spas with fixed water discharge (i.e., on/off only), the throttling system varies the water discharge rates whereby the user experiences varying water pressure on his/her body. This varying water pressure on the body increases the hyrdotherapeutic benefits of the spa. Also, as the various phases are progressing, the throttling module interface may graphically displays the status of the operating mode.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is an elevated perspective view of a portable spa of the invention, showing a spa shell with a variable speed throttling massage system associated with the two seats positioned adjacent a water filtration assembly;

FIG. 2 is a partial perspective view of the portable spa, showing a seat and an associated throttling system;

FIG. 3 is a schematic of the components of the portable spa, showing a first embodiment of the throttling system;

FIG. 4 is a schematic of the components of the portable spa, showing a second embodiment of the throttling system;

FIG. 5 is a collection of basic algorithms employed by the throttling system;

FIG. 6 is a collection of cycle algorithms employed by the throttling system; and,

FIG. 7 is a collection of constant algorithms employed by the throttling system.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

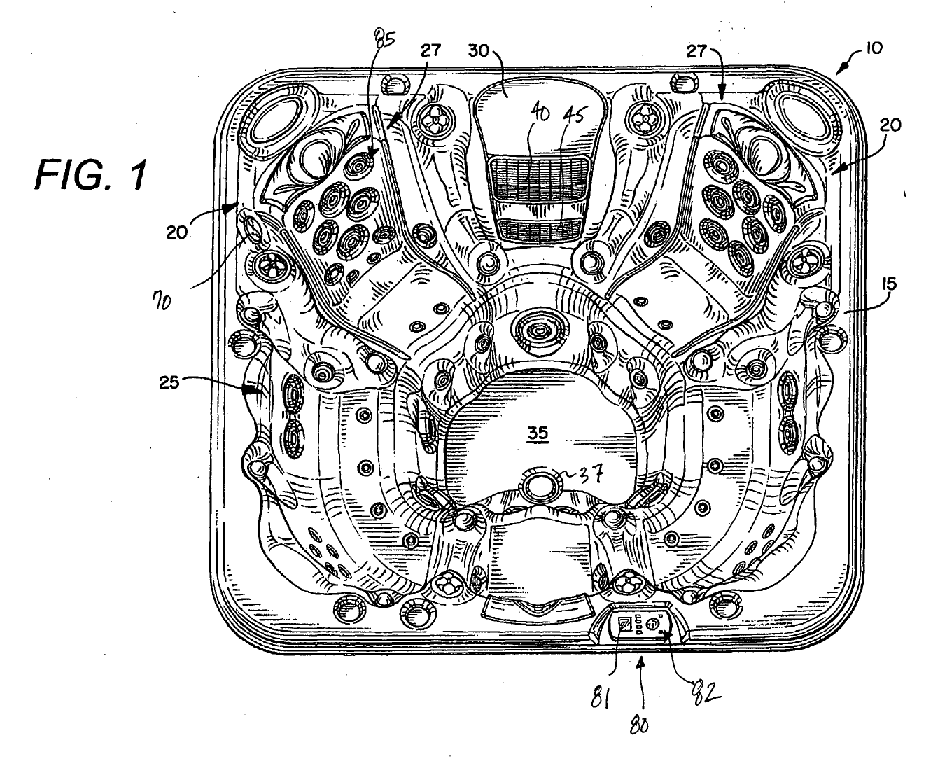

FIGS. 1-7 illustrate a portable spa 10 of the invention. As shown in FIG. 1, the spa 10 includes a shell or tub 15 and a variable speed throttling massage system 20 (referred to herein as throttling system 20) for discharging water into a shell 15. The shell 15 includes a seating arrangement 25 that comprises a plurality of seats 27, wherein each seat has a plurality of discharge jets 85 which may be arranged in distinct groups GR as explained below. In the embodiment of FIG. 1, the throttling system 20 is associated with each of the two seats 27 that are positioned about a water filtration assembly 30. Although shown as having two seats 27 associated with the throttling system 20, the shell 15 may have a greater or fewer number of seats associated with the throttling system 20. As an example, the shell 15 may have four seats 27, each associated with the throttling system 20. Similarly, the shell 15 may have only one seat 27 with a corresponding throttling system 20.

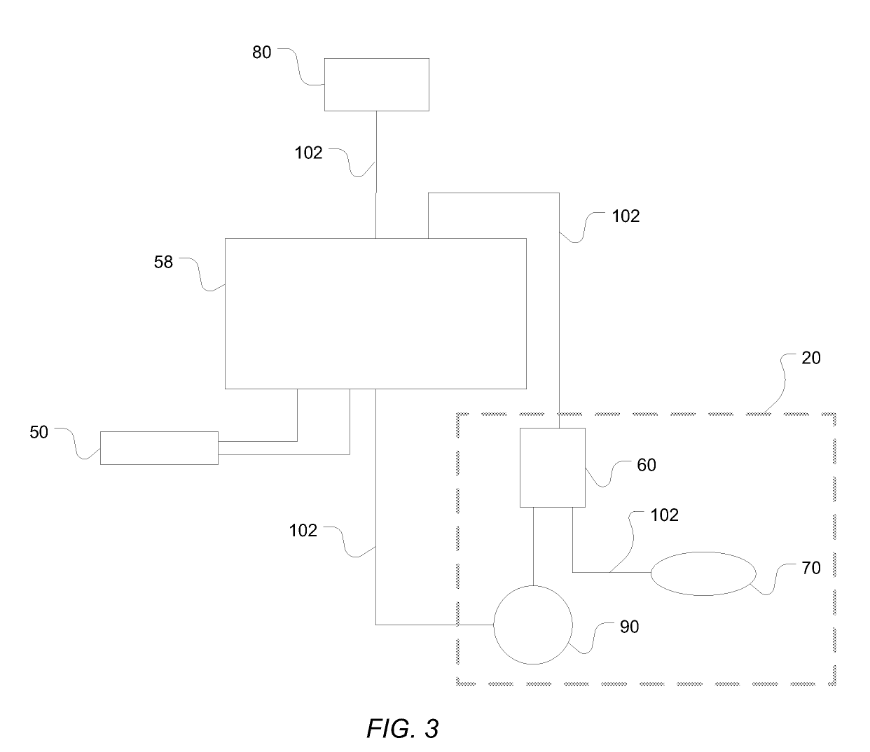

The shell 15 further includes a foot well 35, wherein the seats 27 extend into the well 35. The water filtration assembly 30 includes an upper grill 40 and a lower grill 45 incorporated in a curvilinear housing that extends downward from an upper portion of the shell 15. The shell 15 is supported by an internal support frame (not shown) that comprises a plurality of horizontal frame members and vertical frame members. Various operational components, including an ozonator and a heater assembly, that are utilized to operate the spa 10 are installed within a cavity defined between the support frame and the shell 15. Also, a primary controller 58 (see FIG. 3) includes a microprocessor for operational control of these components and monitoring of the throttling system 20, as explained below. The ozonator, heater assembly, and primary controller 58 are mounted within the cavity by a vertical support tray, as described in pending U.S. patent application Ser. No. 11/592,322, Publication No. 20070118983 (which is incorporated herein by reference). An audio/stereo unit 50 is operably connected to the primary controller 58. A controller interface 80 is operably connected to the primary controller 58, via leads 102 (see FIG. 3) and functions as a top-side controller for the primary spa functions. Although not shown, a hand-held remote control may utilize wireless protocols to communicate with the controller interface 80. The controller interface 80 is programmed for operational functions, such as on/off, timer, water temperature, and audio/video operations. The controller interface 80 is also programmed for diagnostic functions, such as notifying the user if a filter element requires replacement or whether a component requires attention. The controller interface 80 is further programmed for maintenance functions, including filtration cycles to remove particles, algae, and debris from the water at specified times and/or periods of use

FIG. 3 provides a schematic representation of one embodiment of the throttling system 20, which is operably connected by leads 102 to the primary controller 58. The throttling system 20 includes a throttling module 60 that is loaded with a number of throttled water discharge programs, a throttling module interface 70 that is a seat-side user controller for the throttling module 60, and the variable speed motor 90. The primary controller 58, throttling module interface 70 and throttling module 60 cooperate to control the operation of the variable speed motor 90 The input of the variable speed motor 90 is tied to the suction assembly 37 and the output of the variable speed motor 90 connects to the manifold assembly for the supply of throttled water to jets 85 in a seat 27. The manifold assembly comprises a manifold that receives water from the motor 90 and a plurality of lines extending from the manifold to the various jets 85. An additional pump(s) (not shown) may be implemented to supply non-throttled water to seats not associated with the throttling system 20. The additional pump(s) may also be implemented as a dedicated circulation pump, for example to provide necessary water flow to the heater assembly, the ozonator and/or the oxidation/sanitation system. Accordingly, many of the processes that occur in the regular operating cycle of the portable spa 10 may be supplied with water using a low-power consumption, circulation pump having one or more fixed speed settings.

In the embodiment of FIG. 3, the throttling system 20 is associated with a single seat 27 whereby the interface 70 is actuated by a user in that seat 27. In another embodiment, the throttling system 20 is associated with two seats 27 that receive throttled water whereby the interface 70 is shared by the users in those seats 27. In the embodiment of FIG. 3, the throttling system 20 is shown as a sub-system that operably interacts and communicates with the primary controller 58 and with throttled water discharge programs loaded on the throttling module 60. In an alternate version, the discharge programs are stored in the primary controller 58, the module 60 is omitted, and the throttling module interface 70 and the variable speed motor 90 are operably connected to the controller 58.

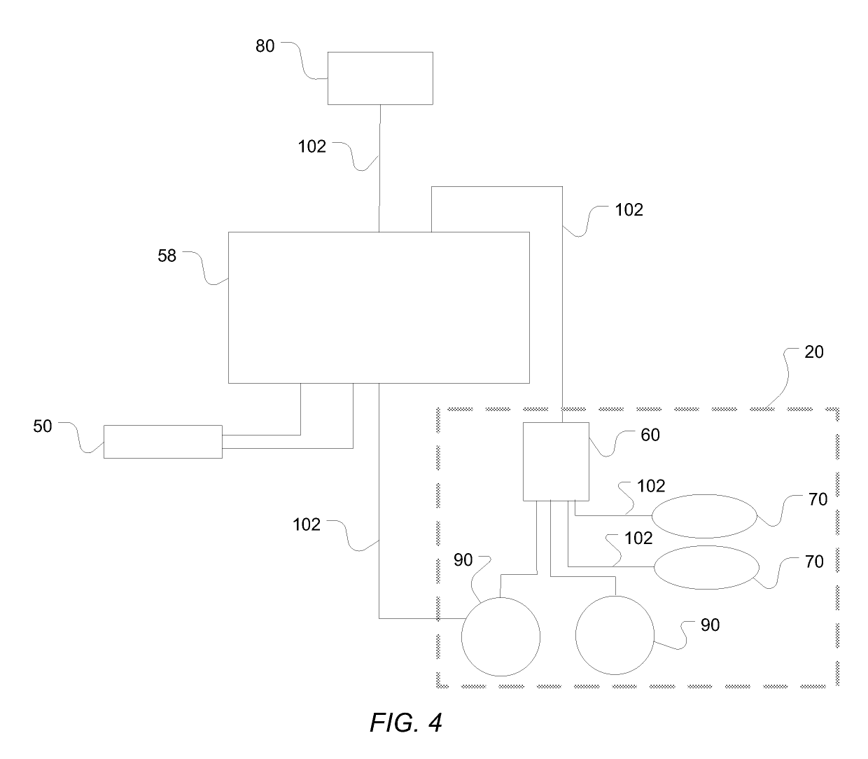

FIG. 4 is a schematic representation of another embodiment of a throttling system 20 including a single throttling module 60 but two throttling module interfaces 70 and two variable speed motors 90 (each joined with a manifold assembly). In this embodiment, the throttling system 20 provides throttled water to two seats 27 based upon commands received from a throttling module interface 70 associated with each seat 27. As such, the throttling module 60 is configured with discharge programs to provide throttled water from each motor 90 to each seat 27 as requested by each interface 70. Depending upon the capacity of the throttling module 60, it may be advantageous to increase the number of throttling modules 60 to correspond to the number of seats 27 receiving throttled water; however, it is contemplated that the number of seats 27 corresponds to the number of throttling module interfaces 70 and variable speed motors 90. While the throttling system 20 of FIG. 4 provides throttled water to two seats 27, additional throttling systems 20 can be added to other seats in the shell 15 and integrated with the primary controller 58 to enable the primary controller 58 to maintains its role in monitoring the operation of the systems 20. For example, the spa 10 may include multiple throttling systems 20 to provide throttled water to all seats 27 and operably connected to the primary controller 58 in a manner consistent with that discussed above and shown in FIG. 3. Thus in a preferred embodiment of the spa 10, a single primary controller 58 has the ability to monitor multiple throttling systems 20, while also monitoring and controlling the operation of the ozonator, heater, audio unit 50 and any pumps that supply water to seats not having a throttling system 20.

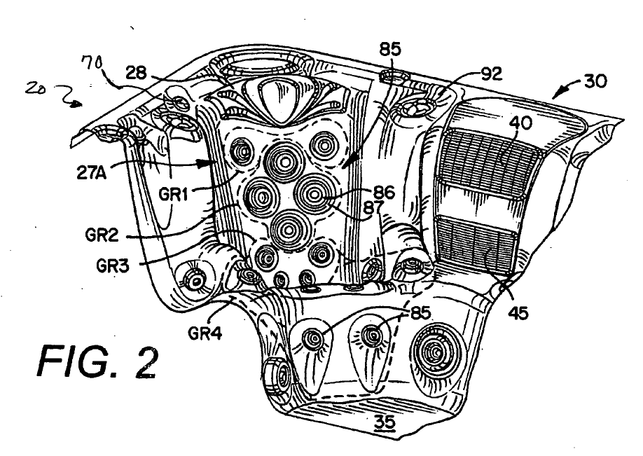

As shown in FIG. 2, the seats 27 includes a collection of jets 85 comprising a ischarge port 86 and a bezel 87, wherein the port 86 extends through the surface of the seat 27a. For example, the seat 27 left of the filter assembly 30 has a first jet group GR 1 that comprises two smaller jets 85 positioned in an upper portion of the seat 27 and below the head cushion 28. In use, these jets 85 supply water to the spa user's shoulder and neck regions. A second jet group GR 2 comprises a cluster of four larger jets 85 in a central portion of the seat 27 that supply water to the user's back. A third jet group GR 3 comprises four intermediate sized jets 85 arrayed in a curvilinear path to supply water to the user's lower back. A fourth jet group GR 4 comprises a pair of jets 85 located at the user's hip region, a pair of jets 85 located at the user's wrist and hand region, and a pair of jets 85 at the user's calf region. To increase the hydrotherapy benefits provided by the throttling system 20, the fourth jet group GR 4 can be expanded to include other jets 85, such as waterfall jets located beyond the seats 27 but within the seating arrangement 25. As explained below, the jet groups GR 1-4 represent distinct regions of the seat 27 where water is discharged from during the operation of the throttling system 20. Although the jet groups GR 1-4 vertically divide the seat 27 into distinct regions, the jet groups GR 1-4 can be rearranged to divide the seat 27 into lateral or side regions, whereby the person sitting in the seat 27 would experience lateral water discharge instead of vertical water discharge from the jets 85. Each jet 85 and the resulting groups GR1-4 are connected to and supplied with throttled water by manifold assembly. An adjustable intake control 92 residing in an upper portion of the shell 15 varies the amount of air supplied to the manifold assembly. It is contemplated that each of these groupings of jets 85 may be separately controlled by its own throttling system 20, including an associated dedicated variable speed pump 90 and manifold assembly 100; however, in the examples further described herein, the jets 85 and jet groups GR1-4 of seat 27 are all associated with a single variable speed pump 90 and manifold assembly 100.

As briefly explained above, the throttling system 20 includes a throttling module 60 loaded with a number of operating modes or programs that control the operation of the throttling system 20, including the throttled discharge of water from the jets 85. Specifically, the operating modes enable the throttling module 60 to control the operation of the associated variable speed motor 90 to supply throttled water (i.e., water at different pressure and rate) in certain sequences to specific jet groups GR1-4. The throttling module 60 is linked or operably connected to the throttling module interface 70, the primary controller 58 and the variable speed pump 60 by electrical leads 102. As explained in greater detail below where the operation of the throttling system 20 is discussed, the throttling module 60 sends a signal through the electrical leads 102 to the variable speed pump 90 to control the rate of flow of water to the jets 85. The throttling module interface 70 is linked to the throttling module 60 to allow for user operation and/or adjustment of the throttling system 20. The throttling module interface 70 is preferably mounted in the shell 15 adjacent the seat 27 such that the occupant of the seat 27 can easily set and/or adjust the operating modes of the throttling system 20 without leaving the seat 27. The throttling module interface 70 includes a number of depressible buttons that correspond to the various operating modes and a graphical display showing the operational mode selected.

Referring to FIGS. 1-3, a controller interface 80 is linked with the primary controller 58 and resides in an upper portion of the shell 15. The controller interface 80 includes a window 81 that displays the operating status of the spa 10, including the throttling system 20. Also, the controller interface 80 has a plurality of depressible buttons 82 to navigate the programs utilized for operation of the spa 10. In one embodiment, the primary controller 58 monitors operation of the throttling system 20, however, operational control of the throttling system 20 resides with the throttling module 60 and the throttling module interface 70. In this manner, the spa user can power-up the spa 10 with the controller interface 80, while the person in the seat 27 controls the operation of the throttling system 20 with the throttling module interface 70. In another embodiment, the primary controller 58 as well as the throttling module 60 and the throttling module interface 70 are configured to provide operational control of the throttling system 20. In yet another embodiment, the spa 10 includes a wireless remote control unit (not shown) that sends signals to the controller interface 80 and/or the throttling module interface 70 for operational control. In this arrangement, the shell 15 may include a recessed cavity that receives the remote control unit, which can be sealed within a buoyant waterproof housing.

The operating mode of the throttling system 20 involves: (i) a throttling parameter, (ii) a sequencing parameter, and (iii) a time parameter, wherein water is supplied at varying rates and pressures to different sequences of jet groups for discharge into the shell 15 over intervals of time. Described in a different manner, the throttling, sequencing and time parameters combine to sequence the discharge of water from various jet groups at varied discharge pressures and rates over predetermined time intervals. Consequently and in contrast to conventional spas, the person sitting in the seat 27 experiences a varying application of water upon his/her body parts as water is discharged from the various jets 85, not just a static discharge of water from all jets 85. The concept of sequenced or phased water discharge through various jets is disclosed in U.S. patent application Ser. No. 11/998,080, which is incorporated herein by reference and shares at least one common inventor with the present Application. The '080 application does not disclose the throttling parameter and its combination with the other two parameters to enable the broader system of supplying water at varying rates and pressures to different sequences of jet groups for an interval of time.

The throttling system 20, namely the throttling module 60, is programmed with operating modes for the throttling parameter, the sequencing parameter, and that time parameter to control the variable speed motor 90, including its discharged water output, and the resultant discharge of water from the jet groups GR1-4. The operation of the throttling system 20 will be discussed from the vantage point of a person sitting in one of seats 27, herein referred to as the “User.” Once the spa 10 is operating, the User activates the throttling system 20 by depressing the buttons on the module interface 70 to select a desired operating mode for the seat 27. Depending upon how the operating modes are defined, throttled water may be supplied to the jets 85 or jet groups GR1-4 in a predetermined pattern, in a repeating or random pattern, at different pressures for set or random time periods. In one embodiment, the operating modes of the throttling module 60 are programmed at the manufacturing facility. In another embodiment, some of the operating modes are pre-programmed and the remaining modes can be programmed by a service technician or the spa owner upon installation of the spa 10.

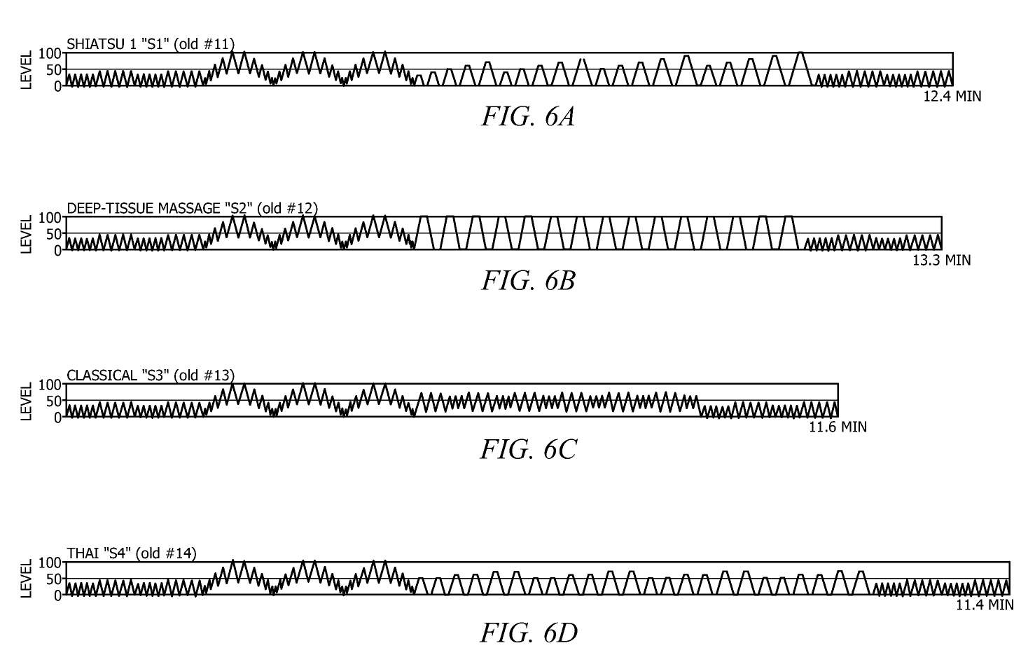

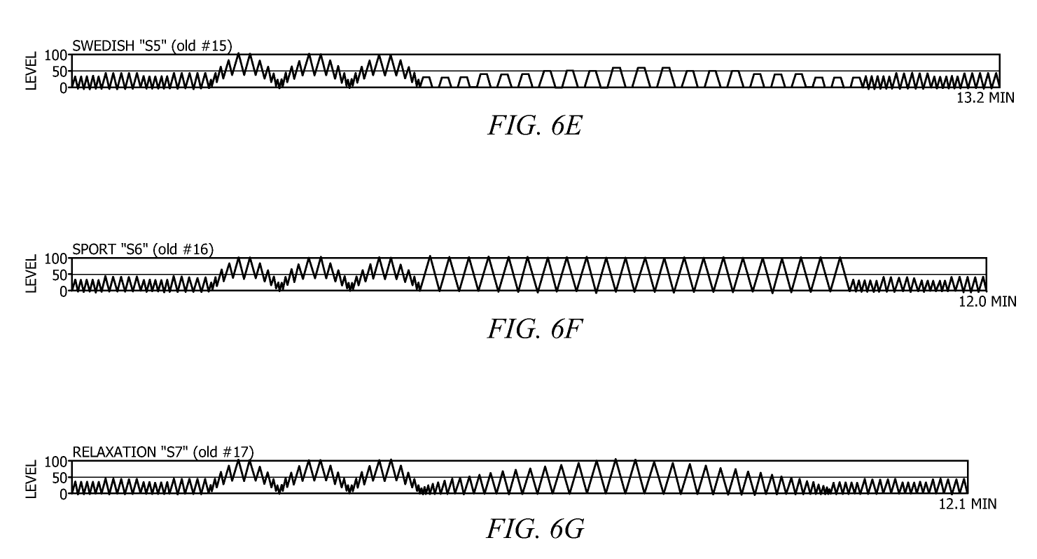

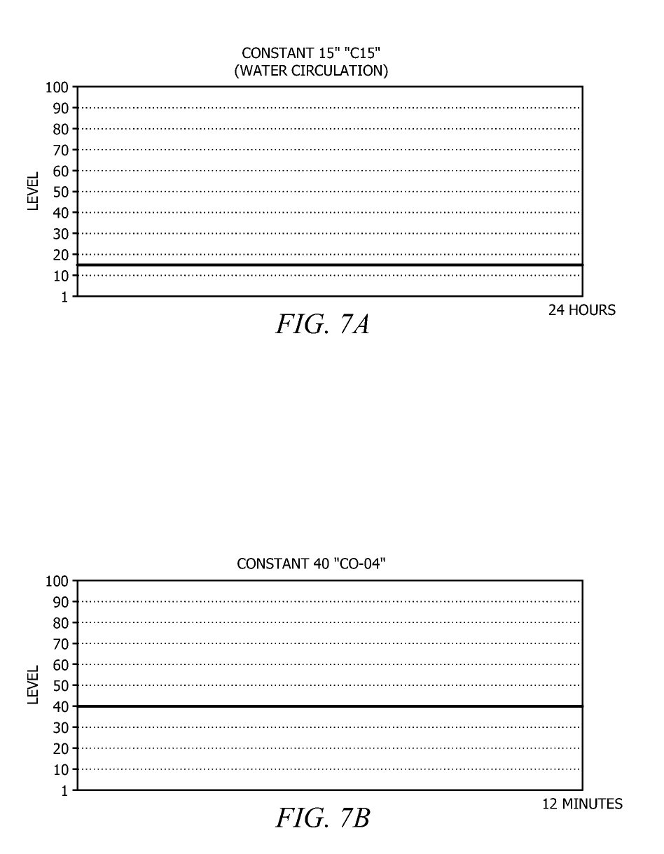

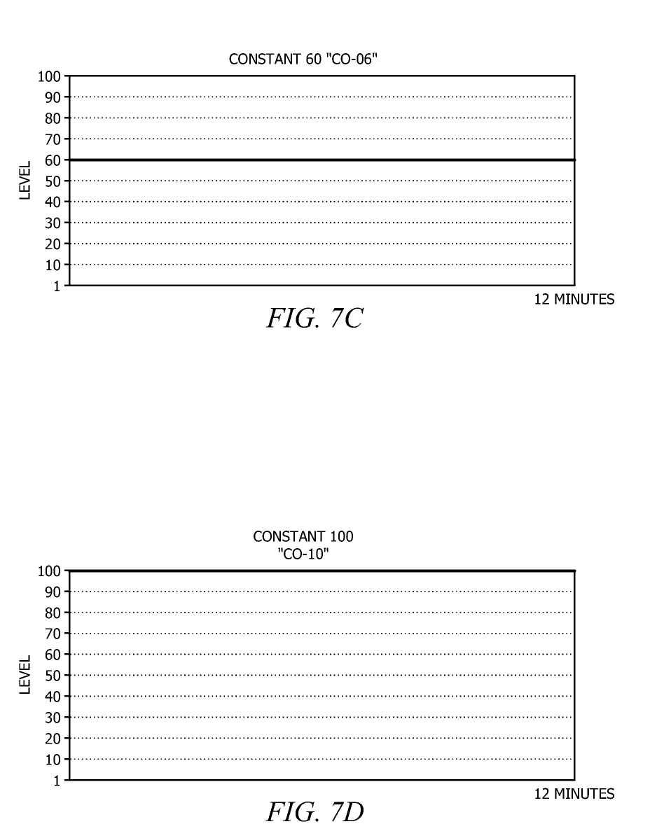

FIGS. 5-7 depict example algorithms within the throttling module 60 for the operating modes, wherein the algorithms reflect the throttling and time parameters. Although the sequencing parameter is not shown in the algorithm, the throttling module 60 determines which sequence of jet groups GR1-4 receive throttled water consistent with the throttling and time parameters of the algorithm/mode selected by the User. The sequence may be a progression through the jet groups GR1-4, may focus on or repeat particular jet groups within the broader group GR1-4, and/or may include a repetition of certain groups and exclusion of other groups within the broader group GR1-4. As shown in these Figs, the variable speed motor 90 is capable of throttling the water supply between (and including) 0% and 100% water pressure. While shown to be adjustable between the 0% and 100% levels in increments of 10%, it is contemplated that the variable speed motor 90 and the throttling module 60 will be able to control the throttled water pressure in any desired increments. In FIG. 5, seven different basic algorithms are shown—friction, vibration, pertrisage, effleaurage, percussion, triggering and rolling—which provides a repetitious massage along the User's body and among the jet groups G1-G4, with throttled water levels being adjustable between 0% (fully closed), 25% (mostly closed), 50% (half power), 75% (mostly open), and 100% (fully open). For the steps in each algorithm, the throttled water level corresponding to the discharge water pressure/rate, the time duration at each level step, and the total algorithm time are shown. It is understood that a program may include various styles or subprograms within a cycle algorithm, as shown in FIG. 6. The cycle algorithms relate to seven different massage techniques—shiatsu, deep, Thai, classic, sport, Swedish, relaxation—that provide sequenced massage patterns along the User's body by varying the discharge pressure and jet groups G1-G4. The cycle algorithms may include a warm-up portion, a central massage portion and a cool down portion, each of which may utilize various throttling levels and techniques to deliver the appropriate massaging water supply. Conversely, it is contemplated that a program may consist entirely of a single throttled delivery pressure, such as those constant programs shown in FIG. 7.

Once the User selects the desired operating mode on the throttling module interface 70, the throttling module 60 sends a series of signals to the other components of the throttling system 20 to effectuate the operating mode. Specifically, the throttling module 60 sends a signal to the primary controller 58 and/or the variable speed motor 90 to supply a sufficient quantity of water at a specific pressure to the manifold assembly 100 for distribution to the designated jet groups G1-G4. Thus, the variable speed motor 90 operates in a dedicated manner—supplying water to only the designated jet groups G1-G4 associated with the specific seat 27 consistent with the operating model selected by the User. The primary controller 58 sends a third signal to the controller interface 80 to graphically show operation of the throttling system 20 in the window 81. In this manner, the components of the throttling system 20, including the variable speed motor 90, the manifold assembly 100, the throttling module interface 70, and the throttling module 60 continuously interact with each other and the primary controller 58 during the operating mode to ensure that the appropriately throttled amounts of water are timely delivered to the jet groups GR1-4 for discharge into the spa 15. The throttling module interface 70 also includes a button allowing the User to increase and/or decrease the discharge water pressure within a particular selected mode, in the event the User desires such adjustment.

It is contemplated that an additional level of throttling may be implemented utilizing a valve assembly associated with either the manifold assembly 100 and/or the jets 85. Accordingly, the valve assembly may allow for fine tuning or additional programming control over the throttled delivery of water from the variable speed motor 90 to the jets 85 associated with the seat 27.

Implementation of the throttling system 20 described herein is dependent, in part, on use of the proper variable speed motor 90. For the examples provided herein, the variable speed motor 90 is the variable speed motor sold under the trade name GE ECM by REGAL-BELOIT, such as, for example, the 2.3 Series. This variable speed motor is appropriate because it is ultra-high efficiency, moisture resistant, programmable, utilizes self regulating constant airflow, and produces little audible noise.

While the specific embodiments have been illustrated and described, numerous modifications come to mind without significantly departing from the spirit of the invention, and the scope of protection is only limited by the scope of the accompanying Claims.

What is claimed is:

1. A portable spa comprising:
a shell having an arrangement of seats; and,
a throttling system associated with one of the seats, wherein the throttling system comprises:
a variable speed pump;
a manifold assembly that receives water from the variable speed pump, the manifold assembly having a plurality of discharge ports;
a plurality of jets, each jet being connected to a respective discharge port of the manifold assembly; and
a throttling module having a plurality of programmed operating modes that control the operation of the variable speed pump for throttle controlled distribution of water from the jets;
wherein during operation of the throttling system, the variable speed pump, the manifold, and the throttling module collectively interact to supply water to the plurality of jets, whereby the plurality of jets, discharge the water into the shell according to the throttled operating mode.

2. The portable spa of claim 1, further comprising a primary controller operably connected to the throttling module and the pump, wherein the primary controller monitors operation of the throttling system and interaction with other operating components.

3. The portable spa of claim 2, wherein the other operating components include an ozonator and a heater assembly.

4. The portable spa of claim 2, further comprising a controller interface operably connected to the primary controller, wherein the controller interface is integrated in the shell.

5. The portable spa of claim 1, wherein the throttling system further includes a throttling module interface operably connected to the throttling module, wherein the throttling module interface is integrated in the shell proximate the seat associated with the throttling system.

6. The portable spa of claim 1, wherein the throttling system includes a suction assembly that supplies water to the variable speed pump.

7. The portable spa of claim 1, wherein each water is discharged at variable speeds from the plurality of jets according to the operating mode selected in the throttling module, The portable spa of claim 1, further comprising a second throttling system associated with a second seat of the shell.

9. The portable spa of claim 9, wherein the second throttling system comprises the same components as the first throttling system, and wherein during operation of the second throttling system, including a second variable speed pump.

10. The portable spa of claim 10, further comprising a primary controller that monitors operation of the first and second throttling systems and the interaction of both systems with other operating components.

11. The portable spa of claim 11, wherein the primary controller is operably connected to the throttling module and the variable speed pumps of the throttling systems by electrical leads.

12. A system for providing a therapeutic throttling in a portable spa having a shell including an arrangement of seats, the system comprising:
a throttling system associated with one of the seats, wherein the throttling system comprises:
a variable speed pump;
a manifold assembly that receives water from the variable speed pump, the manifold assembly having a plurality of discharge ports;
a plurality of jets, each jet being connected to a respective discharge port of the manifold assembly; and
a throttling module having a plurality of programmed operating modes that control the operation of the variable speed pump for throttle controlled distribution of water from the jets;
wherein during operation of the throttling system, the variable speed pump, the manifold, and the throttling module collectively interact to supply water to the plurality of jets, whereby the plurality of jets, discharge the water into the shell according to the operating mode; and
a module interface connected to the throttling module for selecting one of a plurality of throttling programs to be implemented by the throttling system.

13. The system of claim 12, wherein the system includes a second throttling system associated with a second seat.

14. A process for providing therapeutic throttling in a portable spa having a shell including an arrangement of seats, the process comprising the steps of
providing a throttling system associated with one of the seats, wherein the throttling system comprises:
a variable speed pump;
a manifold assembly that receives water from the variable speed pump, the manifold assembly having a plurality of discharge ports;
a plurality of jets, each jet being connected to a respective discharge port of the manifold assembly; and
a throttling module having a plurality of programmed operating modes that control the operation of the variable speed pump for throttle controlled distribution of water from the jets;
wherein during operation of the throttling system, the variable speed pump, the manifold, and the throttling module collectively interact to supply water to the plurality of jets, whereby the plurality of jets, discharge the water into the shell according to the operating mode; and
a module interface for selecting one of a plurality of throttling programs to be implemented by the throttling system;
selecting a throttling program via the module interface; and
implementing the selected throttling program via the throttling system.

15. The process of claim 14 wherein the process of providing a throttling system associated with one of the seats further includes providing a second throttling system associated with a second seat.

16. The portable spa as described above and as shown in Photos and Figure.
